(19) United States
(12) Patent Application Publication
(10) Pub. No.: US 2018/0274542 A1
(43) Pub. Date: Sep. 27, 2018

(54) BEARING PLATE NOISE DAMPER

(71) Applicant: Eaton Corporation, Cleveland, OH (US)

(72) Inventor: GEON-SEOK KIM, Novi, MI (US)

(73) Assignee: Eaton Corporation, Cleveland, OH (US)

(21) Appl. No.: 15/537,972

(22) PCT Filed: Nov. 5, 2015
(86) PCT No.: PCT/US2015/059226

§ 371 Date: Jun. 20, 2017

Related U.S. Application Data
(60) Provisional application No. 62/174,483, filed on Jun. 11, 2015.

(51) Int. Cl. F04C 29/00; F02B 33/38; F02M 35/12; F04C 18/16; F04C 29/06; F04C 29/12

(52) U.S. Cl. CPC F04C 29/0035; F02B 33/38; F02M 35/1216; F02M 35/1288; F04C 2270/14; F04C 29/068; F04C 29/122; F04C 2270/13; F04C 18/16

(57) ABSTRACT

A bearing plate damper for a supercharger comprising a bearing plate, a first shaft bore and a second shaft bore in the bearing plate, a recess centered between the first shaft bore and the second shaft bore, and a perforated panel in the recess.

### FIELD

This application relates to superchargers of the Roots or Twin Screw type having a noise damper in the bearing plate.

### BACKGROUND

Superchargers generate noise via air pulsations. Traditional noise solutions are external to the supercharger and take up a lot of compartment space in the vehicle engine compartment. Add-ons can also be costly.

Reactive acoustic elements, such as Helmholtz resonators, have been used in vehicle intake systems to damp low frequency narrow band noise. But the reactive acoustic elements have limited application in vehicle intake systems because they can be large in size, requiring substantial volume. Dissipative elements, like foam or fiberglass can be used, however, they are effective only with high frequency noise. Foam and fiberglass have also been avoided because they can contaminate the air flow, potentially damaging the supercharger or engine in addition to reducing performance.

### SUMMARY

The systems and methods disclosed herein overcome the above disadvantages and improves the art by way of a bearing plate damper for a supercharger comprising a bearing plate, a first shaft bore and a second shaft bore in the bearing plate, a recess centered between the first shaft bore and the second shaft bore, and a perforated panel in the recess.

A supercharger can comprise the bearing plate damper. Thus, a supercharger comprising a housing comprising a rotor bore, an outlet in an outlet plane, and an inlet in an inlet plane can comprise the bearing plate damper. The inlet plane can be perpendicular to the outlet plane. A first lobed rotor and a second lobed rotor can be positioned in the rotor bore. A bearing plate parallel can be to the inlet plane with the rotor bore between the inlet plane and the bearing plate. A first shaft bore and a second shaft bore can be in the bearing plate. A first rotor shaft can be in the first shaft bore with the first lobed rotor mounted on the first shaft. A second rotor shaft can be in the second shaft bore with the second lobed rotor mounted on the second shaft. The damping recess can be centered between the first shaft bore and the second shaft bore. A perforated panel can be in the recess.

Additional objects and advantages will be set forth in part in the description which follows, and in part will be obvious from the description, or may be learned by practice of the disclosure. The objects and advantages will also be realized and attained by means of the elements and combinations particularly pointed out in the appended claims.

It is to be understood that both the foregoing general description and the following detailed description are exemplary and explanatory only and are not restrictive of the claimed invention.

### BRIEF DESCRIPTION OF THE DRAWINGS

FIG. 1 is a view of a supercharger with respect to a front surface of a bearing plate.

FIG. 2A is view of a bearing plate with respect to a perforated panel

FIG. 2B is a view of a bearing plate rear surface.

FIG. 3 is first view of a recess including a cross-section showing the depth of the recess.

FIG. 4 is an alternative view of a recess including a cross-section showing the depth of the recess.

FIG. 5 is a view of a supercharger housing towards an inlet plane.

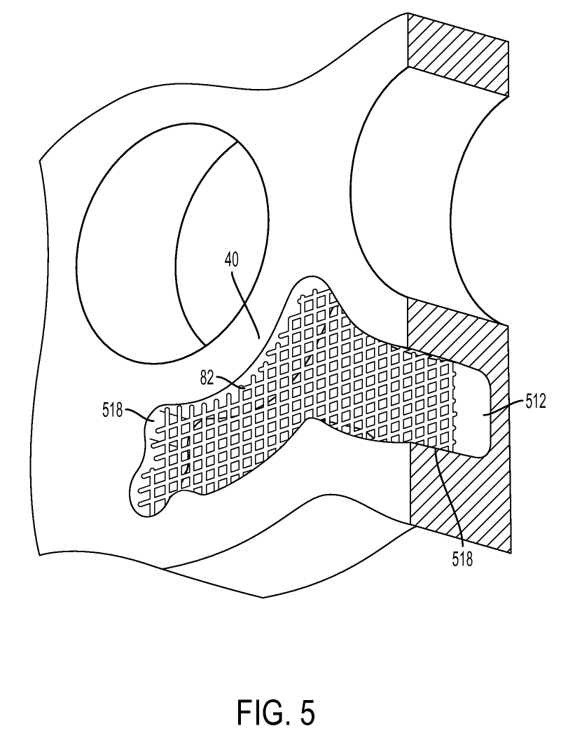

FIG. 6 is a view of a supercharger housing into the rotor bore.

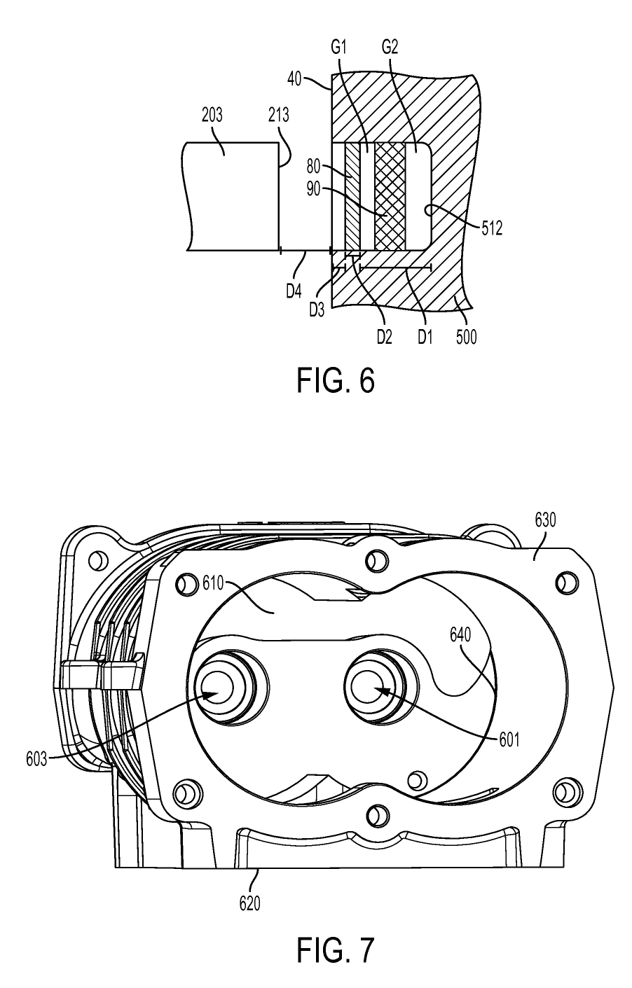

FIG. 7 is a view of twisted lobed rotors with respect to a bearing plate.

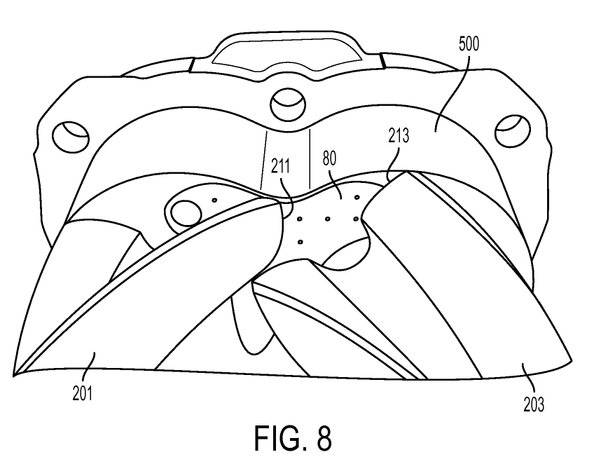

### DETAILED DESCRIPTION

Reference will now be made in detail to the examples which are illustrated in the accompanying drawings. Wherever possible, the same reference numbers will be used throughout the drawings to refer to the same or like parts. Directional references such as “front” and “rear,” or “left” and “right” are for ease of reference to the figures.

Superchargers generate noise via air pulsations. An R-series supercharger housing is equipped with a wide W-port 550 opposite the inlet 610 to promote a back flow process in the supercharger. Extended side areas in the W-port generate backflow of air from the outlet 620 back in to the supercharger transfer cavity, or rotor bore 640. The contrary air flow patterns damp pulsations. The backflow damps noise by easing the transition of the blown air from high to low pressure encounters. However, noise remains an issue.

In addition, or alternatively, to easing the pressure transition of outlet volumes via the W-port, it is possible to ease pressure transitions of inlet volumes by about 5 dB via a recessed damping arrangement in the bearing plate 500. Air pulsations are damped within the supercharger by reflecting waves in another recess 511. A perforated panel 80, which can be a micro-perforated panel, can be spaced within the recess 511 to tune the damping, as by filtering the flow pattern. Air drawn in to the supercharger through the inlet 610 is acted on by the damper (recess 511 and perforated panel 80), which reduces noise in the inlet volume.

The depth of the recess 511 can be selected to tune the damping. The depth, along axis A, impacts the space available to form standing waves and impacts the wavelength reflected or absorbed. The distance between the perforated panel 80 and the front surface 40 of the bearing plate, D3, can be selected to tune the damping and to tune leakage between rotor volumes. The distance between the back wall 512 of the recess 511 and the perforated panel 80 impacts the area available for standing waves. The size of the perforations can also be selected to impact interference among waves and to filter the air flow pattern. The space between the rotor end faces 211, 213 and the perforated panel 80 impacts the amount of space available for air to leak along the perforated panel 80 and between the ends of the lobes of rotors 201, 203. The leakage can alleviate pressure transitions to damp noise. Because the rotor end faces 211, 213 are spaced from the bearing plate front surface 40 to avoid rubbing the bearing plate 500, it is also convenient to refer to a distance D4 from the bearing plate front surface 40 to the rotor end faces 211, 213. The distance D4 can be, for example, 1 mm. However, D4 can also be, for example, in the range of 0.04-0.2 mm. D4 can also be in the range 0.06-0.08 mm. Other distances for D4 can be selected, along with the distance D3 when used, to permit tuning of air leakage between fluid transfer volumes, as outlined below.

A bearing plate damper 580, 590 for a supercharger 600 can comprise a bearing plate 500. A first shaft bore 301 and a second shaft bore 303 are in the bearing plate. A front surface 40 of the bearing plate is opposite the inlet 610 and abuts rotor bore 640. A rear surface 45 of the bearing plate 500 can receive torque transfer mechanisms, such as gears, in recesses of cavity 450.

Recess 511 can be centered between the first shaft bore 301 and the second shaft bore 303, and can span from the base of bearing plate 560 upwards towards the top of the bearing plate 570. The recess 511 can oppose the inlet 610 so as to receive inlet fluid volumes along the rotors. The recess 511 can contact only an inlet transfer volume, and the upper terminus 5111 can be beneath the shaft bores 301, 303. Or, when selecting a controlled leakage from backflow transfer volume, the recess 511 can extend further upwards towards the outlet 620. As drawn, the upper terminus 5111 for the upwards extension of the recess is centered between the shaft bores 301, 303.

As drawn, the first and second lateral terminus 5113, 5115 for the recess 511 are beneath a center point for each of shaft bores 301, 303. The lateral terminus 5223, 5115 extend toward the side surfaces 565 of the bearing plate. The lateral terminus 5113, 5115 are selected to restrict contact of the recess 511 to inlet transfer volumes. However, extending the lateral terminus can permit tuning in the sealed transfer volume. So, by selecting the lateral and vertical extent of the recess 511, one can tune not only noise damping, but can tune leakage within the rotor bore 640 among the inlet, sealed, backflow, and outlet transfer fluid volumes.

In addition to the recess 511 size and shape, it is possible to select among porous material 90, porous material dimensions, perforated panel 80 material, perforated panel dimensions, back flow ports and other aspects to damp certain frequencies and to fit the supercharger bearing plate 500. It is possible to further enhance the damping afforded by the recess 511, and to further tune the frequency of noise damped by the perforated panel 80 by coupling the perforated panel 80 with a porous material 80.

When the perforated panel 80 is used with a porous material 90, the hole size of the perforated panel can be tailored to trap broken down particles of the porous material to avoid contamination. The perforated panel 80 could retain particles of the porous material 90 within the recess 511. The porous material 90 can be, for example, melamine foams, mineral glue, fiberglass, BASOTECT open cell foam by BASF: The Chemical Company, or comparable materials, other melamine foams, melamine resins, or thermoset polymers, or NOMEX flame resistant fiber by DuPont, or comparable materials.

Porous materials such as melamine foams, fiberglass, or mineral glue are subject to deterioration at the operating pressures and heat ranges of a supercharger. But, the perforated panel 80, can be used instead of, or with, the porous material 90. As an example, the perforated panel 80 can be a MILLENNIUM METAL by American Acoustical Products, a division of Ward Process, Inc. The material of the perforated panel 80 and the dimensions of the perforations 81 can be selected to dampen particular frequencies. The porosity can be selected to impact air flow through the perforated panel. The perforated panel 80 comprises a perforated material with a porosity that can vary among perforations of several mm to >1 um, micro-perforations of =<1 um, a mesh layer. The perforated panel 80 can also be another material that dampens noise. The perforations 81 can be a circular shape or other shapes of various diameters and dimensions, such as slits, crenellations, squares, or rectangles. The dimensions and perforation sizes of the micro-perforated panel can be selected and a transfer impedance can be predicted using the equations (1)-(3) below.

Equation 1 can be used to calculate the transfer impedance, where Zₜᵣ is the transfer impedance.

$${Z}_{tr} = \frac{Δ p}{ρ c υ} = \frac{32 η t}{σρ {cd}^{ 2}} ( {( 1 + \frac{{β}^{2}}{32} )}^{1 / 2} + \frac{\sqrt{2}}{8} β \frac{d}{t} ) + j \frac{ω t}{σ c} ( 1 + {( {3}^{2} + \frac{{β}^{2}}{32} )}^{- 1 / 2} + 0.85 \frac{d}{t} ) \qquad eq . ( 1 )$$

In equation (1), the variables and constants are defined as follows:

d=pore diameter

t=panel thickness (e.g. thickness of first portion 8 along axis A)

D=depth of the backing cavity

η=dynamic viscosity

σ=porosity

c=speed of sound

ρ=density of air

ω=angular frequency

Δp=pressure difference

Equation 2 can be used to calculate beta (β), as follows:

β=d\sqrt{ωρ/4η} eq. (2)

Equation 3 can be used to calculate the transfer impedance (Z) with the backing space. Equation 3 is defined as follows:

$$Z = {Z}_{tr} - j cot \frac{ω D}{c} \qquad eq . ( 3 )$$

Z=the transfer impedance with the backing space

j is an imaginary unit, where j²=−1

cot=cotangent.

Equation 4 can be used to calculate αₙ—the normal sound absorption coefficient, where rₙ and xₙ are the real and imaginary parts of the total impedance.

$${α}_{n} = \frac{4 {r}_{n}}{{( 1 + {r}_{n} )}^{2} + {{x}_{n}}^{2}} \qquad eq . ( 4 )$$

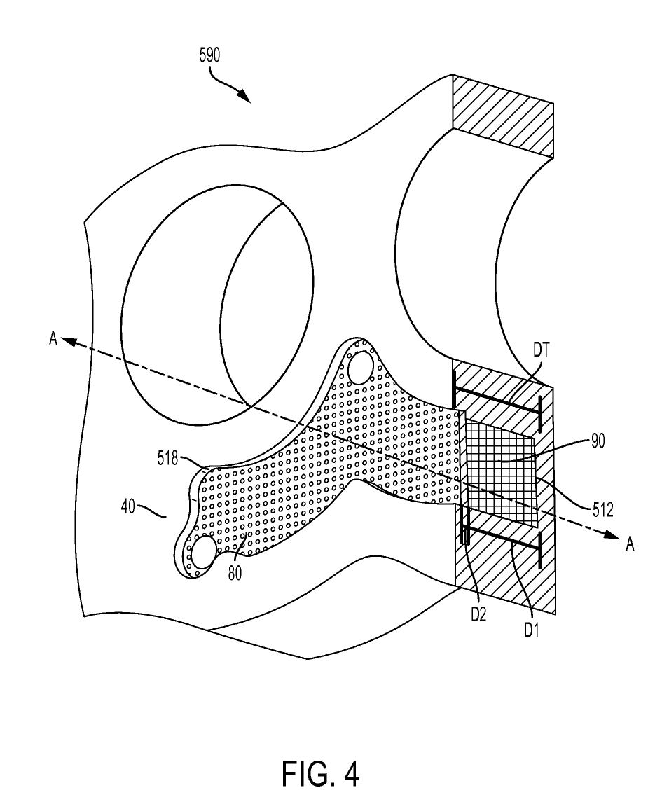

Tradeoffs among the materials selected for the perforated panel include that the mesh panel of FIG. 4 can have a greater porosity than the micro-perforated panel of the other Figures. By selecting the porosity, or open space, of the alternative panels, the panels can perform a retaining function for a porous material. Or, due to greater porosity, an alternative can reduce aerodynamic turbulence without reducing the recess space between the perforated panel 80 and the back wall. Thus, pore sizes for perforations 81 or mesh wire spacing can range from fractions of a millimeter to several millimeters, to more than several millimeters.

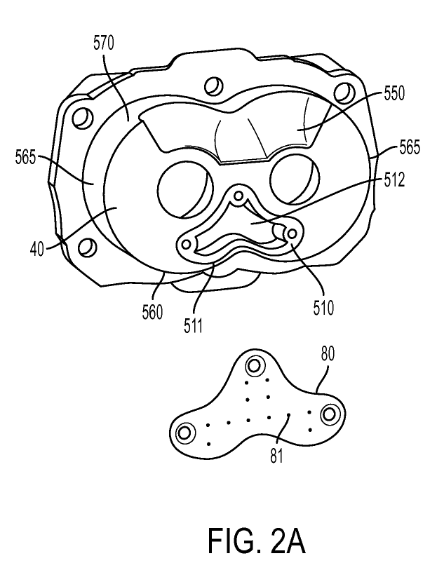

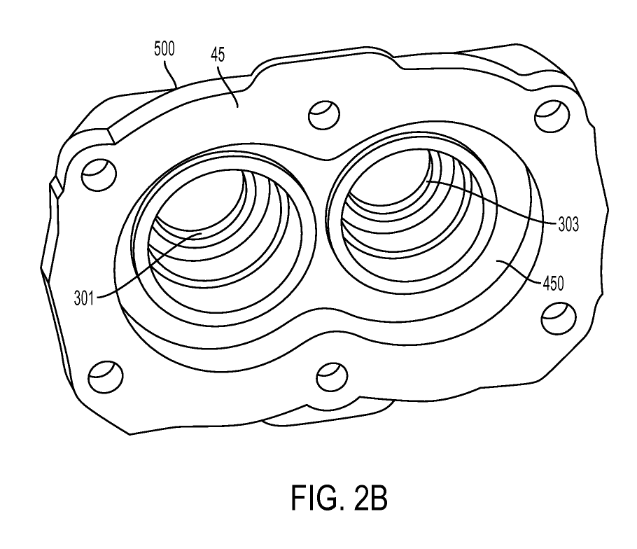

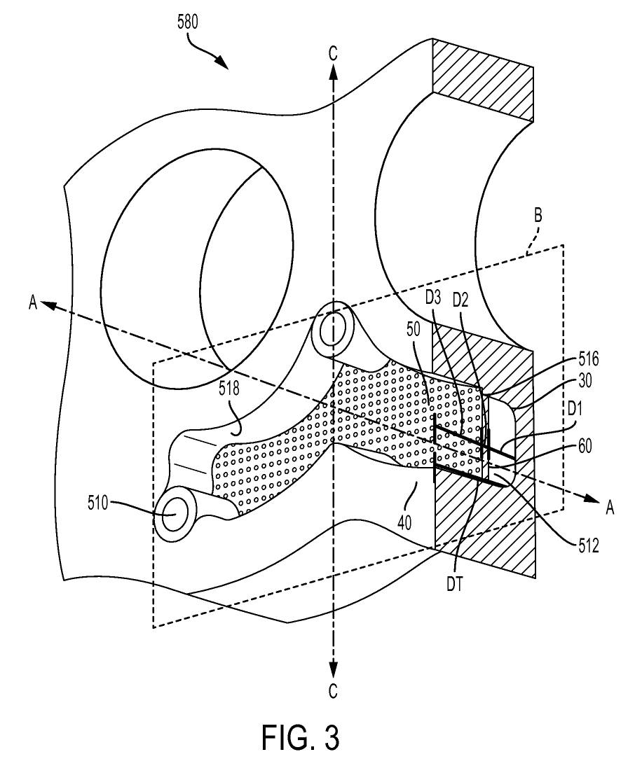

In addition to the porosity, the physical location of the perforated panel 80 and porous material 90 along the A axis impacts tuning. The total depth DT of the recess 511, is illustrated in FIGS. 3 & 4. With respect to the above equations, D, the depth of the backing cavity, is illustrated in FIG. 2 as D1. The panel thickness t in the above equation, is illustrated in FIG. 2 as D2.

D1 is the distance along axis A from back wall 512 to the inner surface 60 of the perforated panel 80. D2 is the distance along axis A of the thickness of the perforated panel. When the outer surface 50 of the perforated panel 80 is not coplanar with the front surface 40 of the bearing plate (as drawn in FIG. 4), D3 is the distance along axis A from the front surface 40 of the bearing plate to the outer surface of the perforated panel 80 (as shown in FIG. 3). D3 can be, for example, 1 mm. D3 can also optionally range from zero to 5 mm, Other values for D3 are possible and permit tuning of air leakage and tuning to reduce air pulsations. DT is the sum of distances D1, D2, and D3.

The perforated panel 80 can be secured to a step 516 on a side wall 518. Or, as shown in FIGS. 2A & 3, a spacer 510 can be used with, or as an alternative to, the step 516. The spacer 510 can be a one-piece tray structure, similar to a gasket, or can be individual caps. The spacer 510 can be inserted in to the recess 511 to space the perforated panel 80 away from the back wall 512. Or, can secure the perforated panel in recess 511 and thereby space the perforated panel from the front surface 40 of the bearing plate. To assist with sealing the perforated panel 80 to the recess 511, gaskets, o-rings, sealants, adhesives or like materials can be used.

It is additionally possible to space or secure the porous material in the recess 511 using the spacer 510 or step 516. For example, the porous material can be surrounded by the step 516, and the perforated panel can retain the porous material in the recess by abutting the step. An air gap G2 can be maintained between back wall 512 and the porous material 90 by additionally stepping the recess 511 or by placing a spacer 510 between the back wall 512 and the porous material. Spacers or steps can also be used to create an air gap G1 between the porous material and the perforated panel. Thus, tuning can be achieved by moving one or both of the perforated panel 80 and the porous material 90 along the A axis. The air gaps permit further tuning by impacting the standing waves in the recess 511.

As shown in FIG. 3, an air gap, or backing space, is between back wall 512 and perforated panel 80 for a distance of D1 along axis A. Low pressure air is transferred to a high pressure region though the perforated panel 80. Air passes through the hollow recess in the region of D3 and creates a very high level of turbulence. The turbulence level of air entering through the perforated panel 80 is reduced in the hollow portion in the region of D1. With the porous material 90 of FIG. 4, the air gap is filled, and D1 comprises the porous material. Air with reduced turbulence intensity is reflected off back wall 512, and the total turbulence intensity is adjusted.

The back wall 512 can be in a plane B perpendicular to axis A, as shown in FIG. 3. And, the damping layers of perforated panel or porous material can be parallel thereto. The interface 30 between sidewalls of the recess 511 and the back wall 512 can be squared off, as shown in FIG. 4, or rounded as shown in FIG. 3.

The shape of recess 511 can be a mirror image along axis C. When choosing recess depth and layer or gap placement along axis A, the total distance DT of the recess 2 can be chosen based on the application. The resulting first, second, and third distances are also selected to tune the air flow. Thus, D3 can be greater than, less than or equal to D2 or D1. D2 can be greater than, less than, or equal to D3 or D1. And D1 can be greater than, less than, or equal to D3 or D2.

The perforated panel 80 and, when used, porous material 90, can conform to the shape of the recess 511. So, when the recess is generally triangular, the perforated panel is generally triangular. When the recess is a generally trefoil shape, and the perforated panel is a generally trefoil shape. When the recess is a generally trianguloid trefoil shape, and the perforated panel is a generally trianguloid trefoil shape. As above, other shapes are also possible.

A supercharger 600 can comprise the bearing plate damper described above. Such a supercharger can comprise a housing comprising a rotor bore 640, an outlet 620 in an outlet plane, an inlet 610 in an inlet plane. The inlet plane can be perpendicular to the outlet plane to form an axial-inlet, radial outlet Roots type supercharger. A first lobed rotor 201 and a second lobed rotor 203 are positioned in the rotor bore. A bearing plate 500 is parallel to the inlet plane, and the rotor bore 640 is between the inlet plane and the bearing plate.

The first rotor 201 can comprise a first rotor shaft in the first shaft bore 301 of the bearing plate, the first lobed rotor mounted on the first shaft. A second rotor shaft can be in the second shaft bore 303, the second lobed rotor 203 mounted on the second shaft. The first and second lobed rotors can comprise twisted lobes.

The perforated panel 80 can damp noise when air pulsations move from the inlet 610 towards the outlet 620. Or, as above, the perforated panel can damp noise when air pulsations backflow from the outlet 620 towards the inlet 610. The backflow damping is particularly helpful when, as above, the W-shaped recess 550 is included on the bearing plate 500 beneath outlet 620 in communication with the outlet and or backflow transfer volumes. The recess 511 can be positioned vertically beneath the outlet 620 in a plane perpendicular to the outlet 620 and in a plane parallel to the inlet 610.

Any of the arrangements described above could be assembled so that a mounting insert (e.g. gasket, bushing plate, spacer) is placed between the perforated panel and or porous material and the housing. And, while the arrangements above show a perforated panel that can be separate from the bearing plate 500 and then fastened to the bearing plate to form a single unit, the perforated panel could be an integral part of the housing, thus, requiring no fasteners. In this arrangement, the perforated panel could be formed in the same manner and at the same time as the supercharger housing, for example, machined, cast, printed using a three-dimensional printer, or a combination of all of the above.

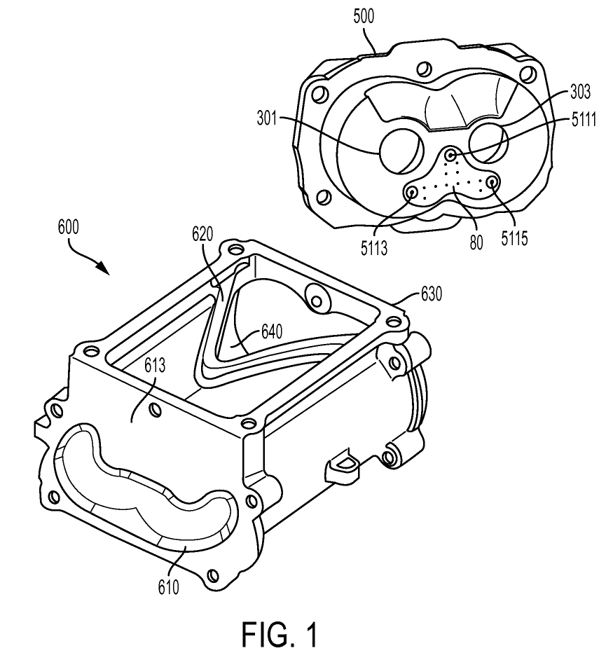

By designing the housing as shown in FIG. 1, the inlet 610 can be formed in the inlet face 613 by machining or casting or printing. Likewise, rotor shaft mounting holes 601, 603 can be formed on the interior side of the inlet face 613. The rotor shafts can be drop-in assembled with their affiliated rotor lobes in place in the rotor bore 640. The bearing plate 500 can be machined, cast, printed, etc. as needed then the bearing plate 500 can be fitted to the rotor shafts thereby mounting rotors 201, 203 to shaft bores 301, 303. The bearing plate 500 can be seated against housing opening 630.

When using the porous material and perforated panel 80 together, it can be beneficial to use the porous material to damp high frequency noise, while tuning the perforated panel to damp the most problematic frequency range, or another range not covered by the porous material. Because the perforated panel can have damping properties in between current reactive and dissipative elements, it is a good addition to a system to augment noise solutions.

Further tuning trades aerodynamics with the frequency attenuated. For example, the larger the backing space created by the recess depth along axis A, the lower the frequency attenuated. And, the less backing space provided, the higher the frequency attenuation.

Other implementations will be apparent to those skilled in the art from consideration of the specification and practice of the examples disclosed herein. It is intended that the specification and examples be considered as exemplary only, with the true scope of the invention being indicated by the following claims.

1. A bearing plate damper for a supercharger comprising:
a bearing plate;
a first shaft bore and a second shaft bore in the bearing plate;
a recess centered between the first shaft bore and the second shaft bore; and
a perforated panel in the recess.

2. The bearing plate damper of claim 1, wherein the recess comprises an axis A, a side wall and a back wall, and wherein the perforated panel is offset from the back wall in the axial direction.

3. The bearing plate damper of claim 2, wherein the bearing plate comprises a rear surface, a front surface comprising the first shaft bore, the second shaft bore, and the recess, and a side surface between the front surface and the rear surface, wherein the perforated panel is a sheet material with an outer surface and an inner surface, wherein the inner surface faces the back wall, and wherein the outer surface is coplanar with the front surface of the bearing plate.

4. The bearing plate damper of claim 2, wherein the bearing plate comprises a rear surface, a front surface comprising the first shaft bore, the second shaft bore, and the recess, and a side surface between the front surface and the rear surface, wherein the perforated panel is a sheet material with an outer surface and an inner surface, wherein the inner surface faces the back wall, and wherein the outer surface is receded a distance D3 from the front surface of the bearing plate and in to the recess.

5. The bearing plate damper of claim 4, wherein the outer surface is receded 1 mm from the front surface of the bearing plate and in to the recess.

6. The bearing plate damper of any one of claims 1-5, further comprising a porous material retained in the recess by the perforated panel.

7. The bearing plate damper of claim 6, wherein the recess comprises an axis A, a side wall and a back wall, and wherein the porous material is offset from the back wall a distance D1 in the axial direction.

8-14. (canceled)

15. The bearing plate damper of claim 1, further comprising a spacer, the spacer abutting the perforated panel.

16-19. (canceled)

20. The bearing plate damper of claim 1, further comprising a W-shaped recess centered between the first shaft bore and the second shaft bore, wherein the first shaft bore and the second shaft bore are between the W-shaped recess and the recess.

21. The bearing plate damper of claim 1, wherein the recess is shaped as one of generally triangular, generally trefoil shape, or generally trianguloid trefoil shape, and wherein the perforated panel conforms to the shape of the recess.

22. (canceled)

23. (canceled)

24. A supercharger, comprising:
a housing comprising a rotor bore, an outlet in an outlet plane, an inlet in an inlet plane perpendicular to the outlet plane;
a first lobed rotor and a second lobed rotor, the first lobed rotor and the second lobed rotor positioned in the rotor bore;
a bearing plate parallel to the inlet plane, the rotor bore between the inlet plane and the bearing plate;
a first shaft bore and a second shaft bore in the bearing plate;
a first rotor shaft in the first shaft bore, the first lobed rotor mounted on the first shaft;
a second rotor shaft in the second shaft bore, the second lobed rotor mounted on the second shaft;
a recess centered between the first shaft bore and the second shaft bore; and
a perforated panel in the recess.

25. The supercharger of claim 24, wherein the recess comprises an axis, a side wall and a back wall, and wherein the perforated panel is offset from the back wall in the axial direction.

26. The supercharger of claim 25, wherein the bearing plate comprises a rear surface, a front surface comprising the first shaft bore, the second shaft bore, and the recess, and a side surface between the front surface and the rear surface, wherein the perforated panel is a sheet material with an outer surface and an inner surface, wherein the inner surface faces the back wall, and wherein the outer surface is coplanar with the front surface of the bearing plate.

27. The supercharger of claim 24, wherein the bearing plate comprises a rear surface, a front surface comprising the first shaft bore, the second shaft bore, and the recess, and a side surface between the front surface and the rear surface, wherein the perforated panel is a sheet material with an outer surface and an inner surface, wherein the inner surface faces the back wall, and wherein the outer surface is receded from the front surface of the bearing plate and in to the recess.

28. The supercharger of claim 27, wherein the outer surface is receded 1 mm from the front surface of the bearing plate and in to the recess.

29. The supercharger of claim 24, further comprising a porous material retained in the recess by the perforated panel.

30-50. (canceled)

51. The supercharger of claim 24, wherein the bearing plate is spaced a distance D4 from an end face of the first lobed rotor mounted to the first shaft bore, and wherein the distance D4 is in the range 0.04-0.2 mm.

52. (canceled)

53. The supercharger of claim 24, wherein the bearing plate comprises a bearing face facing the rotor bore, wherein the perforated panel recedes a distance D3 away from the bearing face along an axis A, and wherein D3 is in the range from 0-5 mm.

54. (canceled)

55. The supercharger of claim 24, further comprising a W-shaped recess centered between the first shaft bore and the second shaft bore, wherein the W-shaped recess is positioned below the outlet in the supercharger housing, wherein the first shaft bore and the second shaft bore are between the W-shaped recess and the recess, wherein the perforated panel is positioned with respect to the inlet in the supercharger housing to damp noise when air pulsations move from the inlet towards the outlet, and wherein the W-shaped recess damps noise when air pulsations move from the outlet towards the inlet.

56. The supercharger of claim 24, wherein the perforated panel is positioned below the outlet in the supercharger housing and is positioned with respect to the inlet in the supercharger housing to damp noise when air pulsations move from the inlet towards the outlet.

57. The supercharger of claim 24, wherein the perforated panel is positioned below the outlet in the supercharger housing and is positioned with respect to the inlet in the supercharger housing to damp noise when air pulsations backflow from the outlet towards the inlet.
